(19) United States
(12) Patent Application Publication
(10) Pub. No.: US 2026/0128463 A1
(43) Pub. Date: May 7, 2026

(54) COMPOSITE SEPARATOR AND ELECTROCHEMICAL DEVICE INCLUDING THE SAME

(71) Applicant: SK IE TECHNOLOGY CO., LTD., Seoul (KR)

(72) Inventors: Cheol Min YUN, Daejeon (KR); Dong Jae KIM, Daejeon (KR); Eun Ji OH, Daejeon (KR); Hee Joon JUNG, Daejeon (KR)

(21) Appl. No.: 19/376,623

(22) Filed: Oct. 31, 2025

(30) Foreign Application Priority Data
Nov. 7, 2024 (KR) 10-2024-0156847

(51) Int. Cl. H01M 50/446; H01M 50/414; H01M 50/434; H01M 50/443; H01M 50/449

(52) U.S. Cl. CPC H01M 50/446; H01M 50/414; H01M 50/434; H01M 50/443; H01M 50/449

(57) ABSTRACT

Composite separators, methods for manufacturing the composite separators, and electrochemical devices including the composite separators are disclosed. In an embodiment, a composite separator includes: a porous substrate; and a ceramic layer formed on at least one surface of the substrate. Specifically, the ceramic layer includes inorganic particles, a binder, and a particulate fusing agent and satisfies the following Equation 1, and the binder is carboxymethyl cellulose having a weight average molecular weight of 180,000 g/mol to 280,000 g/mol. The composite separator based on the disclosed technology may secure excellent heat resistance, adhesive strength, and fusion strength with an electrode:

$$0.9 < \frac{T \times ( W 1 + W 2 )}{W 2 \times D} < 2.4 \qquad [ Equation 1 ]$$

wherein T, W1, W2, and D are as defined in the specification.

### PRIORITY CLAIM AND CROSS-REFERENCE TO RELATED APPLICATIONS

This patent document claims the priority and benefits of Korean Patent Application No. 10-2024-0156847 filed in the Korean Intellectual Property Office on Nov. 7, 2024, the disclosure of which is incorporated herein by reference in its entirety.

### TECHNICAL FIELD

The disclosed technology relates to a separator and an electrochemical device including the same.

### BACKGROUND

In recent years, as electrochemical devices have gained greater capacity and output, there has been a growing demand for improved heat resistance and safety. In particular, the performance requirements for separators, which play an important role in ensuring heat resistance and safety of the electrochemical devices, have become more advanced. For example, composite separators comprising an inorganic coating layer that includes inorganic particles such as alumina (Al₂O₃), silica (SiO₂), and zirconia (ZrO₂), along with a binder applied to a porous substrate, have emerged as an important technology.

### SUMMARY

An embodiment of the disclosed technology provides a composite separator that includes a particulate fusing agent along with a ceramic layer, thereby exhibiting excellent heat resistance, adhesive strength, and fusion strength with an electrode even at a small thickness, which minimizing the occurrence of a blocking phenomenon.

Another embodiment of the disclosed technology provides an electrochemical device that includes the composite separator.

In one general aspect, a composite separator includes: a porous substrate; and a ceramic layer disposed on at least one surface of the substrate, wherein the ceramic layer includes inorganic particles, a binder including carboxymethyl cellulose having a weight average molecular weight in a range of 180,000 g/mol to 280,000 g/mol, and a particulate fusing agent, wherein the ceramic layer satisfies the following Equation 1:

$$0.9 < \frac{T \times ( W 1 + W 2 )}{W 2 \times D} < 2.4 \qquad [ Equation 1 ]$$

Wherein:
T is a thickness (μm) of the ceramic layer;
W1 is a content (wt %) of the binder relative to a total weight of the ceramic layer;
W2 is a content (wt %) of the particulate fusing agent relative to the total weight of the ceramic layer; and
D is an average particle diameter (μm) of the particulate fusing agent.

The particulate fusing agent may have an average particle diameter (D50) in a range of 1 μm to 10 μm.

The ceramic layer may have a total thickness in a range of 1 μm to 20 μm.

The carboxymethyl cellulose may have a degree of substitution in a range of 0.6 to 1.2.

The inorganic particles may have an average particle diameter (D₅₀) in a range of 0.01 μm to 1 μm.

The inorganic particles may include at least one of boehmite, pseudo-boehmite, BaSO₄, CeO₂, MgO, CaO, ZnO, Al₂O₃, SiO₂, TiO₂, BaTiO₃, HfO₂, SrTiO₃, SnO₂, NiO, ZrO₂, Y₂O₃, or SiC.

The inorganic particles may be included at 90 to 99 wt % with respect to the total weight of the ceramic layer.

The binder may be included at 0.1 wt % to 10 wt % with respect to the total weight of the ceramic layer.

The particulate fusing agent may be included at 0.1 wt % to 10 wt % with respect to the total weight of the ceramic layer.

The binder and the particulate fusing agent may be included at a weight ratio of 5:5 to 8:2.

The particulate fusing agent may have a glass transition temperature (Tg) in a range of 40° C. to 80° C.

The porous substrate may be hydrophilically surface-treated.

The composite separator implemented based on an example embodiment may exhibit heat shrinkage rates in machine direction (MD) and transverse direction (TD) of 4% or less, wherein the heat shrinkage rates in MD and TD are measured after the composite separator is allowed to stand at 150° C. for 60 minutes.

The heat shrinkage rate of the composite separator was measured based on the ASTM D1204 standard, but the following method was used. Lattice points were marked at 2 cm intervals on a square with one side of 10 cm on the composite separator specimen, and one side of the square was the transverse direction (TD) and the other one was the machine direction (MD). The specimen was placed right in the center, 5 sheets of paper were placed on and under the specimen, respectively, the four sides of the paper were taped, and the taped specimen was allowed to stand in a hot air drying oven at 150° C. for 60 minutes. Thereafter, the specimen was taken out, and the separator was observed with a camera to calculate the shrinkage rate in the machine direction (MD) and the shrinkage rate in the transverse direction (MD) at an ambient temperature.

When the composite separator implemented based on an example embodiment is subjected to a cardboard test, a ratio of an area occupied by foreign matter smeared on a surface of a cardboard to at total area of the cardboard may be 5% or less.

Here, the cardboard test may comprise:

placing a black cardboard and a rubber pad having a size of 2 cm×10 cm sequentially on a ceramic layer of a composite separator specimen having a size of 5 cm×10 cm; pulling the cardboard horizontally at a speed of 0.1 m/s for a distance of 60 mm while applying a force of 10 N to the rubber pad using a pressing device; and evaluating a degree of foreign matter smeared on the surface of the cardboard.

In another general aspect, an electrochemical device includes: a positive electrode, a negative electrode, and a composite separator, wherein the composite separator includes: a porous substrate; and a ceramic layer disposed on at least one surface of the substrate, wherein the ceramic layer includes: inorganic particles; a binder including carboxymethyl cellulose having a weight average molecular weight in a range of 180,000 g/mol to 280,000 g/mol; and a particulate fusing agent, wherein the ceramic layer satisfies the following Equation 1:

$$0.9 < \frac{T \times ( W 1 + W 2 )}{W 2 \times D} < 2.4 \qquad [ Equation 1 ]$$

Wherein:
T is a thickness (μm) of the ceramic layer;
W1 is a content (wt %) of the binder relative to the total weight of the ceramic layer;
W2 is a content (wt %) of the particulate fusing agent relative to the total weight of the ceramic layer; and
D is an average particle diameter (μm) of the particulate fusing agent.

Other features and aspects will be apparent from the following detailed description, the drawings, and the claims.

### BRIEF DESCRIPTION OF THE DRAWINGS

FIG. 1 shows a cross section of a composite separator based on an example embodiment.

FIG. 2 is a schematic plan view of an electrochemical device based on an example embodiment.

FIG. 3 is a schematic cross-sectional view of an electrochemical device based on an example embodiment.

### DETAILED DESCRIPTION

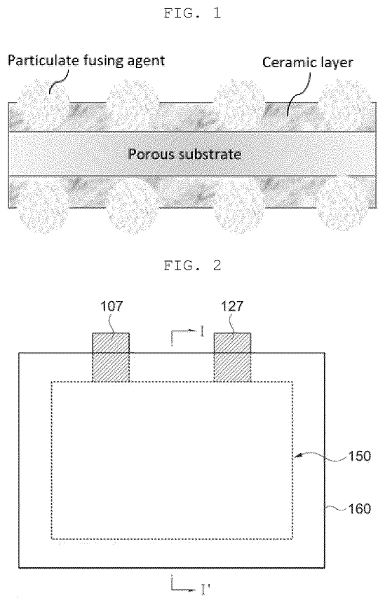

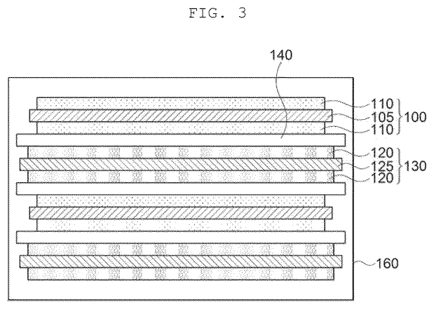

FIG. 2 is a schematic plan view of an example of an electrochemical device based on one embodiment for implementing the technology disclosed in this document. This electrochemical device may be a secondary batter, and the secondary battery has a battery case 160 which contains the components of the battery such as the battery's electrode assembly 150 with two protruded electrodes: a positive electrode lead 107 and a negative electrode lead 127 for electrical connections for outputting battery power and for being charged.

FIG. 3 is a schematic cross-sectional view of an example of an electrochemical device to illustrates certain components within the battery, including a positive electrode 100 that includes a positive electrode current collector 105 and two positive electrode mixed layers 110 on the two opposite sides, and a negative electrode 130 that includes a negative electrode current collector 125 and two negative electrode mixed layers 120 on two opposite sides. Between them is a separator 140.

The numerical range used in some embodiments includes all values within the range including the lower limit and the upper limit, increments logically derived from the form and spanning of a defined range, all double limited values, and all possible combinations of the upper limit and the lower limit in the numerical range defined in different forms. Unless otherwise defined in embodiments, values which may be outside a numerical range due to experimental error or rounding off of a value are also included in the defined numerical range.

Unless otherwise particularly defined in embodiments, “about” may be considered as a value within 30%, 25%, 20%, 15%, 10%, or 5% of a stated value.

In some embodiments, an “average particle diameter” refers to “D50”, and “D50” refers to a particle diameter of a sample particle to be measured which corresponds to 50% in terms of a volume-based accumulated fraction. The average particle diameter may be derived from particle size distribution results obtained by collecting a sample of particles to be measured in accordance with the standard of ISO 13320-1 and performing analysis using analytical instruments for particle size and shape (e.g., S3500 available from MICROTRAC), in which the sample to be measured refers to inorganic particles and a particulate fusing agent.

In some embodiments, carboxymethyl cellulose (CMC) refers to a cellulose derivative that is etherified by substituting a hydroxyl group (—OH) of cellulose with —OCH₂COOH and/or —OCH₂CO⁻M⁺ where M⁺ is an alkali metal cation selected from lithium (Li), sodium (Na), potassium (K), rubidium (Rb), cesium (Cs), francium (Fr), and the like. In some embodiments, the term “degree of substitution (DS)” of carboxymethyl cellulose refers to the average number of the substituents present in one anhydrous glucose unit in a cellulose molecule. The DS value may be measured by a known or conventional method, for example, in accordance with ASTM D1439 or calculated by ¹H-NMR or ¹³C-NMR analysis.

The degree of substitution (DS) of carboxymethyl cellulose (CMC) was measured according to a titration method based on ASTM D1439. The experiment was carried out using a magnetic stirrer, aspirator, dry oven, 300 mL beaker, pipette, 250 mL Erlenmeyer flask, and Petri dish. The reagents used included 80% ethanol, 100% ethanol, 0.1 N sodium hydroxide (NaOH), phenolphthalein indicator, and 0.1 N sulfuric acid (H₂SO₄). Specifically, 150 mL of 80% ethanol was added to a 300 mL beaker, followed by 10 mL of 1 N nitric acid (HNO₃). Approximately 1-2 g of CMC sample was introduced into the beaker and stirred for 1 hour to convert the sodium salt form of CMC into the acid form (CMC-acid). After allowing the mixture to stand for about 10-20 minutes, the supernatant was decanted. Then, 150 mL of 80% ethanol was added again and stirred for 30-40 minutes, followed by decanting the supernatant once more. The precipitated CMC-acid was filtered using an aspirator and washed with 500 mL of 80% ethanol, followed by one or two washes with 100% ethanol. The central portion of the CMC-acid was collected in a clean weighing dish and dried in a dry oven for 20-30 minutes. After drying, approximately 0.2±0.05 g of the dried sample was weighed accurately, and 25 mL of 0.1 N NaOH solution was added. The sample solution was then transferred to a 250 mL Erlenmeyer flask containing 100 mL of distilled water and stirred for 40-60 minutes until completely dissolved. Two to three drops of phenolphthalein were added as an indicator, and the solution was titrated with 0.1 N H₂SO₄ while stirring until the color changed from red to colorless. The number of millimoles of CMC-acid per gram of dried sample (A) was determined according to the following equation:

$$A = \frac{( millimoles of CMC Acid )}{Sample dry weight ( g )}$$

The degree of substitution (DS) was then calculated from A using the following equation:

$$B ( D . S . value ) = \frac{162 \times A}{10 , 000 - 58 \times A} .$$

Hereinafter, the disclosed technology will be described in detail. However, it is only illustrative, and the disclosed technology is not limited to the specific example embodiment illustratively described.

In some cases, composite separators often lack sufficient adhesion to an electrode. As a result, the separator may be separated from the electrode during a cell assembly process, leading to distortion, deformation, or other damage to the electrode assembly, and potentially causing a short circuit between electrodes, which may result in a safety issue. One approach to address these issues may include separately applying an adhesive layer capable of boding with an electrode on an inorganic coating layer. However, this approach add additional processing steps and increasing manufacturing costs, making it challenging to commercialize. Furthermore, the added adhesive layer can increase the internal resistance of a battery and negatively affect its electrical performance.

In some approaches, a fusing agent capable of forming fusion strength with an electrode is introduced to the inorganic coating layer. However, as thinning of separators has become more prevalent to meet the high-capacity, high-output demands of electrochemical devices, issues such as blocking phenomena have occurred. These occur due to the desorption of a fusing agent when sufficient fusion strength is required within a limited thickness range. Some embodiments of the disclosed technology provide a new type of separator that can address these issues.

An example embodiment of the disclosed technology provides a composite separator that may secure sufficient fusion strength with an electrode even in a limited thickness range, while simultaneously (i) exhibiting excellent anti-blocking performance, (ii) exhibiting excellent adhesive strength between inorganic particles and between inorganic particles and a substrate in a coating layer, and (iii) reducing or preventing heat shrinkage at a high temperature.

Specifically, the composite separator based on an example embodiment includes: a porous substrate; and a ceramic layer disposed on at least one surface of the substrate, wherein the ceramic layer includes inorganic particles, a binder including carboxymethyl cellulose having a weight average molecular weight in a range of 180,000 g/mol to 280,000 g/mol, and a particulate fusing agent, wherein the ceramic layer satisfies the following Equation 1:

$$0.9 < \frac{T \times ( W 1 + W 2 )}{W 2 \times D} < 2.4 \qquad [ Equation 1 ]$$

Wherein:
T is a thickness (μm) of the ceramic layer;
W1 is a content (wt %) of the binder relative to a total weight of the ceramic layer;
W2 is a content (wt %) of the particulate fusing agent relative to the total weight of the ceramic layer; and
D is an average particle diameter (μm) of the particulate fusing agent.

Since the composite separator based on an example embodiment uses CMC having a specific molecular weight range as described above as the binder and satisfies the range of Equation 1 by having a specific relationship of the thickness of the ceramic layer, the contents of the binder and the particulate fusing agent, and the average particle diameter of the particulate fusing agent, it may exhibit sufficient fusion strength with an electrode. In addition, it may exhibit excellent heat resistance as compared with a conventional separator having a ceramic layer with the same thickness, and may exhibit excellent adhesive strength between the inorganic particles and between the inorganic particles and the substrate, thereby effectively suppressing desorption of the inorganic particles and a shrinkage phenomenon at a high temperature. In addition, the composite separator based on an example embodiment may effectively suppress desorption and blocking phenomena of inorganic particles and/or a particulate fusing agent during winding.

In an example embodiment, the thickness (T) of the ceramic layer is not particularly limited as long as the range of Equation 1 is satisfied by the combination of the content (W1) of the binder, the content (W2) of the particulate fusing agent, and the average particle diameter (D) of the particulate fusing agent, but may be, for example, 0.1 μm to 10 μm, 0.5 μm to 10 μm, 0.5 μm to 8 μm, 0.5 μm to 5 μm, 1 μm to 5 μm, 1.2 μm to 5 μm, or 1.5 μm to 3 μm. The numerical range disclosed herein may include all possible combinations of the upper limits and the lower limits of the numerical ranges.

In an example embodiment, the total thickness of the ceramic layer may be 0.1 μm to 20.0 μm, 0.1 μm to 10.0 μm, 0.5 μm to 10.0 μm, 1 μm to 10 μm, 2 μm to 8 μm, 2 μm to 5 μm, or 3 μm to 5 μm. The numerical range disclosed herein may include all possible combinations of the upper limits and the lower limits of the numerical ranges. In some embodiments, the total thickness of the ceramic layer refers to the thickness of the ceramic layer formed on one surface of the porous substrate when the composite separator implemented based on an example embodiment includes the ceramic layer formed on one surface of the porous substrate. In some embodiments, the total thickness of the ceramic layer refers to the sum of the thicknesses of the ceramic layers formed on two opposite surfaces of the porous substrate when the composite separator based on an example embodiment includes the ceramic layer formed on two opposite surfaces of the porous substrate, and the thicknesses of the ceramic layer formed on two opposite surfaces may be the same as or different from each other.

In an example embodiment, since the carboxymethyl cellulose (CMC) satisfies a weight average molecular weight range of 180,000 g/mol to 280,000 g/mol, even when CMC is used alone as the binder of the ceramic layer, excellent adhesive strength between inorganic particles and between inorganic particles and a substrate and heat resistance may be simultaneously satisfied, and when forming the ceramic layer, a coating slurry has appropriate viscosity to facilitate formation of a coating layer. As an example, when the weight average molecular weight of CMC is less than 180,000 g/mol, sufficient adhesive strength may not be implemented, and when it is more than 280,000 g/mol, the coating layer (ceramic layer) may not be formed.

In an example embodiment, the carboxymethyl cellulose may have the weight average molecular weight of 180,000 to 280,000 g/mol, 180,000 to 260,000 g/mol, 180,000 to 250,000 g/mol, 190,000 to 250,000 g/mol, or 20,000 to 250,000 g/mol. The numerical range disclosed herein may include all possible combinations of the upper limits and the lower limits of the numerical ranges. The weight average molecular weight may refer to a weight average molecular weight converted with a molecular weight calibration curve using a polysaccharide standard sample measured by a gel permeation chromatography (GPC) method. The GPC method may be carried out at an ambient temperature, and the sample is prepared by dissolving CMC at a concentration of approximately 0.1% w/v in a standard reference solvent. The prepared solution is then injected into the GPC instrument for analysis.

In addition, the carboxymethyl cellulose may have the degree of substitution of 0.6 or more, 0.7 or more, 0.8 or more, 0.9 or more, 1.5 or less, 1.2 or less, 1.1 or less, or 1.0 or less, specifically, 0.6 to 1.5, 0.6 to 1.2, 0.6 to 1.1, 0.7 to 1.1, 0.7 to 1.0, or 0.8 to 1.0. The numerical range disclosed herein may include all possible combinations of the upper limits and the lower limits of the numerical ranges.

Since carboxymethyl cellulose satisfying the combination of the weight average molecular weight and the degree of substitution range is used, the effect of simultaneously improving heat resistance and adhesive strength may be further improved. For example, applicability when applying a coating slurry on the surface of the porous substrate during formation of the ceramic layer is improved, heat resistance is enhanced even when the ceramic layer on the composite separator is thin, and adhesive strength between the inorganic particles or between the ceramic layer and the porous substrate is also improved.

In an example embodiment, the particulate fusing agent may have an average particle size of 1 μm or more, 1.5 μm or more, 2.0 μm or more, 2.5 μm or more and 10 μm or less, 8 μm or less, 6 μm or less, or 5 μm or less, or 1 μm to 10 μm, 1 μm to 8 μm, 1 μm to 6 μm, or 2 μm to 6 μm. The numerical range disclosed herein includes all possible combinations of the upper limits and the lower limits of the numerical ranges, improving fusion strength with an electrode.

In an example embodiment, the particulate fusing agent may have a glass transition temperature (T_{g}) of 40° C. or higher, 45° C. or higher, 50° C. or higher and 100° C. or lower, 90° C. or lower, or 80° C. or lower, or 40° C. to 100° C., 40° C. to 90° C., or 40° C. to 80° C. The numerical range disclosed herein may include all possible combinations of the upper limits and the lower limits of the numerical ranges. When the range is satisfied, fusion strength between the composite separator and the electrode may be enhanced, and the battery can exhibit improved battery performance after the battery assembly. In some embodiments, the glass transition temperature may range from 40° C. to 70° C. Within this range, the fusing agent may not flow in a drying step of the composite separator, is not deformed in a coating step and during a shipping process, and minimizes changes in the air permeability of the substrate even after fusing, thereby maintaining excellent performance.

The particulate fusing agent is not particularly limited as long as it can provide fusion strength with an electrode, but may, for example, be an acryl-based polymer, a urethane-based polymer, or a copolymer including them.

The acryl-based polymer may be a homopolymer including an alkyl (meth)acrylate-based monomer polymerization unit or a copolymer including the alkyl (meth)acrylate-based monomer polymerization unit. The copolymer including the alkyl (meth)acrylate-based monomer polymerization unit may be a copolymer including an alkyl (meth)acrylate-based monomer polymerization unit; and one or more polymerization units selected from a styrene-based monomer polymerization unit, a butadiene-based monomer polymerization unit, and a vinyl-based monomer polymerization unit.

The alkyl (meth)acrylate-based monomer may be a C1-C10 alkyl (meth)acrylate-based monomer, C1-C6 alkyl (meth)acrylate-based monomer, or C1-C4 alkyl (meth)acrylate-based monomer, and specifically, one or more selected from methyl (meth)acrylate, ethyl (meth)acrylate, and n-butyl (meth)acrylate.

A non-limiting example of the particulate fusing agent may be polyurethane beads, polyurethane acryl beads, epoxy-acryl beads, polystyrene-polybutyl methacrylate-polymethyl methacrylate (PS-PBMA-PMMA), polybutyl methacrylate-polymethyl methacrylate (PBMA-PMMA) polystyrene-polydimethylsiloxane-polybutyl methacrylate (PS-PDMS-PBMA), polystyrene-polydimethylsiloxane-polymethyl methacrylate (PS-PDMS-PMMA), or polydimethylsiloxane-polymethyl methacrylate (PDMS-PMMA), but the disclosed technology is not limited thereto.

In some embodiments, the particulate fusing agent may be manufactured by a known manufacturing method, such as emulsion polymerization or suspension polymerization, and thus, detailed description thereof will be omitted.

In an example embodiment, the type of inorganic particles is not limited. As a non-limiting example, the type of inorganic particles may be one or more selected from metal oxides, metal hydroxide, metal carbides, metal nitrides, and metal carbonitrides, such as boehmite, pseudo-boehmite, BaSO₄, CeO₂, MgO, CaO, ZnO, Al₂O₃, SiO₂, TiO₂, BaTiO₃, HfO₂, SrTiO₃, SnO₂, NiO, ZrO₂, Y₂O₃, and SiC.

In an example embodiment, the inorganic particles may have an average particle diameter (D50) of, for example, 0.01 μm or more, 0.02 μm or more, 0.05 μm or more, 0.1 μm or more and 0.01 μm to 10 μm, 0.02 μm to 5.0 μm, 0.1 μm to 3.0 μm, 0.1 μm to 2.0 μm, 0.1 μm to 1.0 μm, or 0.1 μm to 0.5 μm. The numerical range disclosed herein may include all possible combinations of the upper limits and the lower limits of the numerical ranges, but the disclosed technology is not limited thereto.

In an example embodiment, the ceramic layer may include the inorganic particles at 90 to 99.9 wt %, 92 to 99.5 wt %, 92 to 99 wt %, 90 to 99 wt %, 95 to 99 wt %, or 95 to 98 wt %, with respect to the total weight of the ceramic layer.

In an example embodiment, the content (W1) of the binder may be 0.01 wt % or more, 0.1 wt % or more, 0.5 wt % or more, 1 wt % or more, 1.5 wt % or more, 2 wt % or more, 10 wt % or less, 8 wt % or less, or 5 wt % or less, or 0.01 wt % to 10 wt %, 0.1 wt % to 10 wt %, 0.5 wt % to 5 wt %, or 1 to 5 wt %, with respect to the total weight of the ceramic layer. The numerical range disclosed herein may include all possible combinations of the upper limits and the lower limits of the numerical ranges.

In an example embodiment, the content (W2) of the particulate fusing agent may be 0.1 wt % or more, 0.5 wt % or more, 1.0 wt % or more, more than 1.0 wt %, 1.1 wt % or more, or 1.2 wt % or more and 10 wt % or less, 5 wt % or less, 4 wt % or less, 3 wt % or less, 2 wt % or less, or less than 2 wt %, specifically 0.5 wt % to 5 wt %, 1 wt % to 5 wt %, 1 wt % to 3 wt %, 1 wt % to 2 wt %, or more than 1 wt % and less than 2 wt %, with respect to the total weight of the ceramic layer. The numerical range disclosed herein may include all possible combinations of the upper limits and the lower limits of the numerical ranges.

In an example embodiment, the ceramic layer may include the binder at 10 parts by weight or less, 8 parts by weight or less, 5 parts by weight or less, 3 parts by weight or less, 2 parts by weight or less, or 1 part by weight or less and 0.01 parts by weight or more, 0.1 parts by weight or more, 0.5 parts by weight or more, 1 part by weight or more, 2 parts by weight or more, specifically 0.1 to 5 parts by weight, 1 to 5 parts by weight, or 1 to 3 parts by weight, with respect to 100 parts by weight of the inorganic particles, or at a content between the numerical ranges.

In an example embodiment, the binder and the particulate fusing agent may be included at a weight ratio of 5:5 to 9:1, 5:5 to 8:2, or 5:5 to 7:3.

In an example embodiment, heat shrinkage rates in MD and TD directions of the composite separator which is measured after the separator is allowed to stand at 150° C. for 60 minutes may be both 5% or less, specifically 3% or less, 2.5% or less, 2.0% or less, 1.5% or less, 1.0% or less, or 0.5% or less.

In addition, in an example embodiment, when a degree of foreign matter smeared on the surface of a cardboard is evaluated after a cardboard test of the composite separator, a ratio of an area occupied by the smeared foreign matter to an area of the cardboard may be 5% or less, specifically less than 5%, less than 4%, less than 3%, less than 2%, or less than 1.5%.

The cardboard test method involves placing a black cardboard and a rubber pad having a size of 2 cm×10 cm sequentially on an upper surface of a ceramic layer of a composite separator specimen having a size of 5 cm×10 cm, and pulling out the cardboard horizontally at a speed of 0.1 m/s for a distance of 60 mm in a state of applying a force of 10 N to the rubber pad using a pressing device to evaluate an area as a degree of foreign matter smeared on the surface of the cardboard, in which the foreign matter may be the constituent components of the ceramic layer, for example, the inorganic particles, the binder, or a combination thereof.

When the adhesive strength is evaluated using the cardboard test method as described above, measurement may be performed considering adhesive strength between the inorganic particles in the ceramic layer as well as adhesive strength between interfaces of the substrate and the ceramic layer, and from the results of the adhesive strength test, a heat shrinkage degree may be predicted more accurately as compared with a conventional peel test. That is, when a ratio of an area occupied by the smeared foreign matter calculated by the cardboard test is less than 5%, less than 4%, less than 3%, less than 2%, or less than 1.5%, it means that adhesive strengths between the inorganic particles and between the inorganic particles and the substrate are all excellent, and the heat shrinkage phenomenon may be effectively suppressed.

As an example, a method such as a peeling test commonly used for evaluating adhesive strength of an inorganic particle coating layer in a composite separator can be used to evaluate adhesive strength between interfaces of the substrate and the inorganic particle coating layer. However, it may be difficult to evaluate the adhesive strength between the inorganic particles, or the evaluated value may not accurately reflect the heat shrinkage characteristics of the separator.

In an example embodiment, the porous substrate is not limited as long as it is commonly used in the art, and for example, may be a woven fabric, a non-woven fabric, or a porous film. Specifically, the porous substrate may be polyolefins such as polyethylene and polypropylene, polyesters such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenyleneoxide, cyclic olefin copolymer, polyphenylenesulfide, polyethylenenaphthalate, glass fiber, Teflon, and/or polytetrafluoroethylene, and any two or more of them may be used. Among the porous substrates, a porous film is manufactured by a dry method or a wet method known in the art.

In an example embodiment, the porous substrate may have a porosity of 20 to 60%, 30 to 60%, 30 to 50%, or 35 to 45%, but the disclosed technology is not limited thereto.

In an example embodiment, the porous substrate may have a polar functional group introduced by performing a hydrophilic surface treatment, the polar functional group may be a carboxyl group, an aldehyde group, a hydroxyl group, and others, and the hydrophilic surface treatment may be, as an example, a corona discharge treatment or a plasma discharge treatment, but the disclosed technology is not limited thereto.

In an example embodiment, the thickness of the porous substrate is not particularly limited, and for example, may be 1 μm to 100 μm, 1 μm to 50 μm, 1 μm to 30 μm, 5 μm to 20 μm, or any value between the numerical values.

Another example embodiment of the disclosed technology provides a method for manufacturing the composite separator that includes: applying a composition for forming a ceramic layer including inorganic particles, a binder, and a particulate fusing agent on at least one surface of a porous substrate and drying the composition to form a ceramic layer, wherein the binder is carboxymethyl cellulose having a weight average molecular weight of 180,000 g/mol to 280,000 g/mol, and the ceramic layer satisfies the following Equation 1:

$$0.9 < \frac{T \times ( W 1 + W 2 )}{W 2 \times D} < 2.4 \qquad [ Equation 1 ]$$

wherein
T is a thickness (μm) of the ceramic layer;
W1 is a content (wt %) of the binder relative to the total weight of the ceramic layer;
W2 is a content (wt %) of the particulate fusing agent relative to the total weight of the ceramic layer; and
D is an average particle diameter (μm) of the particulate fusing agent.

Since the porous substrate, the binder, and the inorganic particles have been described above, detailed description will be omitted.

The composition for forming a ceramic layer may be prepared by dispersing the binder and the inorganic particles, and the agglomerated inorganic particles may be dispersed using a ball mill.

The composition for forming a ceramic layer further includes a solvent, and the solvent may be water, lower alcohols such as ethanol, methanol, and propanol, solvents such as dimethylformamide, acetone, tetrahydrofuran, diethyl ether, methylene chloride, N-methyl-2-pyrrolidone, hexane, and cyclohexane, or a mixture thereof, but the disclosed technology is not necessarily limited thereto.

In an example embodiment, although a solid content of the composition for forming a ceramic layer is not particularly limited, it may be, for example, 1 to 50 wt %, 5 to 30 wt %, or 10 to 30 wt %, but the disclosed technology is not limited thereto. In addition, the composition for forming a ceramic layer may have a viscosity based on a solid content of 25 wt % of 800 to 5,000 mPa s, 800 to 4,000 mPa s, 800 to 3,000 mPa s, or 1,000 to 3,000 mPa s. This viscosity range may facilitate the formation of the ceramic layer and may further improve the heat resistance and adhesive strength of the separator.

In an example embodiment, although a method for applying or coating the composition for forming a ceramic layer on the porous substrate is not particularly limited, coating methods such as roll coating, spin coating, dip coating, bar coating, die coating, slit coating, or inkjet printing may be used.

In an example embodiment, the drying may be performed by drying by warm air, hot air, or low-humidity air, vacuum drying, or irradiation with far infrared rays, electron beams, or others. Since the drying temperature is not particularly limited, it may be appropriately adjusted depending on the experimental environment or the purpose, and for example, may be 30° C. to 120° C., 30° C. to 100° C., 50° C. to 80° C., or 50° C. to 70° C. The drying time is not particularly limited, but it may be 30 seconds to 300 seconds, 60 seconds to 300 seconds, 100 seconds to 300 seconds, 150 seconds to 250 seconds, or about 180 seconds.

Another example embodiment of the disclosed technology provides an electrochemical device including the composite separator based on an example embodiment, and the electrochemical device may be, as an example, a lithium secondary battery.

Specifically, the electrochemical device based on an example embodiment includes: a positive electrode, a negative electrode, and a composite separator, wherein the composite separator includes a porous substrate and a ceramic layer formed on one surface or two opposite surfaces of the substrate, the ceramic layer includes inorganic particles, a binder, and a particulate fusing agent and satisfies the following Equation 1, and the binder is carboxymethyl cellulose having a weight average molecular weight of 180,000 g/mol to 280,000 g/mol:

$$0.9 < \frac{T \times ( W 1 + W 2 )}{W 2 \times D} < 2.4 \qquad [ Equation 1 ]$$

wherein
T is a thickness (μm) of the ceramic layer;
W1 is a content (wt %) of the binder relative to the total weight of the ceramic layer;
W2 is a content (wt %) of the particulate fusing agent relative to the total weight of the ceramic layer; and
D is an average particle diameter (μm) of the particulate fusing agent.

Hereinafter, the electrochemical device based on an example embodiment will be described using a lithium secondary battery as an example, but it may be manufactured with a structure known in the art using a common manufacturing method and common materials in the art, except for including the composite separator based on an example embodiment of the disclosed technology.

As an example, the lithium secondary battery may be manufactured using a common manufacturing method of placing a negative electrode, the composite separator, and a positive electrode sequentially, assembling them, and injecting an electrolyte to complete the battery.

### [Positive Electrode]

The positive electrode may include a positive electrode current collector and a positive electrode mixed layer on at least one surface of the positive electrode current collector, the positive electrode may be manufactured by forming the positive electrode mixed layer by applying a positive electrode material slurry on at least one surface of the positive electrode current collector, drying, and rolling, and the positive electrode material slurry may include a positive electrode active material and a binder, and if necessary, may further include a conductive material, a thickening agent, or others.

The positive electrode current collector may include a stainless steel, nickel, aluminum, titanium, or an alloy thereof, and may include aluminum or a stainless steel which is surface-treated with carbon, nickel, titanium, or silver. The thickness of the positive electrode current collector may be, for example, 10 μm to 50 μm, but the disclosed technology is not limited thereto.

The positive electrode active material is a compound capable of reversibly intercalating and deintercalating lithium ions and may be used without limitation as long as it is commonly used in the art, and as a non-limiting example, it may be a composite oxide of lithium with a metal selected from cobalt (Co), manganese (Mn), nickel (Ni), iron (Fe), niobium (Nb), magnesium (Mg), copper (Cu), zinc (Zn), molybdenum (Mo), tantalum (Ta), tungsten (W), aluminum (Al), or a combination thereof.

In an example embodiment, the positive electrode active material may be a lithium-nickel composite oxide, and the lithium-nickel composite oxide may further include one or more selected from cobalt, manganese, and aluminum. In some embodiments, the lithium-nickel composite oxide may include materials other than those listed above.

In an example embodiment, the positive electrode active material may include a lithium nickel-cobalt-manganese (NCM)-based composite oxide, and though the composition of the metal is not particularly limited, a high capacity (high-Ni) composition having a high nickel content may be used, and the content of Ni in the NCM-based lithium oxide (e.g., a mole fraction of nickel of the total moles of nickel, cobalt, and manganese) may be 0.3 or more, 0.4 or more, 0.5 or more, 0.6 or more, 0.7 or more, or 0.8 or more. In some example embodiments, the content of Ni may be 0.8 to 0.95, 0.82 to 0.95, 0.83 to 0.95, 0.84 to 0.95, 0.85 to 0.95, or 0.88 to 0.95. The NCM-based composite oxide may be, for example, LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1}Mn_{0.1}O₂, and the like, but the disclosed technology is not limited thereto.

In an example embodiment, the positive electrode active material may be, for example, lithium cobalt oxide-based, lithium manganese oxide-based, lithium nickel oxide-based, lithium iron phosphate-based (LFP, e.g., LiFePO₄), lithium manganese phosphate-based (e.g., LiMnPO₄), lithium cobalt phosphate-based (e.g., LiCoPO₄), lithium iron pyrophosphate-based (e.g., Li₂FeP₂O₇) materials, or others.

The positive electrode binder is not particularly limited as long as it is commonly used in the art. In some embodiments, the positive electrode binder may include a nonaqueous binder and/or an aqueous binder or include a rubber-based binder and/or a fluorine-based binder, and for example, may include one or more selected from acryl-based polymers such as polyacrylate, polymethacrylate, polybutylacrylate, and polyacrylonitrile, fluorine-based polymers such as polyvinylidene fluoride, polyhexafluoropropylene, polyvinylidene fluoride-hexafluoropropylene, and polyvinylidene fluoride-trichloroethylene, polyvinyl acetate, polyethylene oxide, cellulose, modified cellulose, polyamide, polyacrylamide, rubber, elastomer, and others, but is not limited thereto.

The conductive material may be added for increasing conductivity of the positive electrode mixed layer and/or mobility of lithium ions or electrons. For example, the conductive material may be a linear conductive material and/or a dot-shaped conductive material, and for example, may include carbon-based conductive materials such as graphite, carbon black, acetylene black, ketjen black, graphene, carbon nanotubes, vapor-grown carbon fiber (VGCF), carbon fiber, and carbon nanofiber, and/or metal-based conductive materials including tin, tin oxide, titanium oxide, perovskite materials such as LaSrCoO₃ and LaSrMnO₃, and others, but the disclosed technology is not limited thereto. As used herein, the term “dot-shaped conductive material” refers to a general spherical or particulate form of conductive material.

### [Negative Electrode]

The negative electrode may include a negative electrode current collector and a negative electrode mixed layer on at least one surface of the negative electrode current collector, the negative electrode may be manufactured by forming the negative electrode mixed layer by applying a negative electrode material slurry on at least one surface of the negative electrode current collector, drying, and rolling, and the negative electrode material slurry may include a negative electrode active material and a binder, and if necessary, may further include a conductive material, a thickening agent, or others.

The negative electrode current collector may include a copper foil, a nickel foil, a stainless steel foil, a titanium foil, a nickel foam, a copper foam, a polymer substrate coated with a conductive metal, or others. The negative electrode current collector may have a thickness of, for example, 10 μm to 50 μm, but the disclosed technology is not limited thereto.

The negative electrode active material is a material capable of adsorbing and desorbing lithium ions and may be used without limitation as long as it is commonly used in the art, and as a non-limiting example thereof, carbon-based materials such as crystalline carbon, amorphous carbon, a carbon composite, and carbon fiber; lithium metal; lithium alloy; silicon (Si)-containing materials, tin (Sn)-containing materials, and others may be used.

An example of the amorphous carbon may include hard carbon, soft carbon, coke, mesocarbon microbeads (MCMB), mesophase pitch-based carbon fibers (MPCF), or others, and an example of the crystalline carbon may include graphite-based carbon such as natural graphite, artificial graphite, graphitized coke, graphitized MCMB, and graphitized MPCF.

An element included in the lithium alloy may include aluminum, zinc, bismuth, cadmium, antimony, silicon, lead, tin, gallium, indium, or others.

The silicon-containing material may provide more increased capacity characteristics. The silicon-containing material may include Si, SiOₓ (0<x≤2), metal-doped SiOₓ (0<x≤2), a silicon-carbon composite, or others, the metal may include lithium and/or magnesium, and the metal-doped SiOₓ (0<x≤2) may include a metal silicate. The materials described above which may be used in manufacture of the positive electrode may be used as the binder, the conductive material, and the thickening agent of the negative electrode.

The negative electrode binder is not particularly limited as long as it is commonly used in the art, and may be rubber-based binders such as a styrene-butadiene rubber (SBR)-based binder, carboxymethyl cellulose (CMC), polyacrylic acid, poly(3,4-ethylenedioxythiophene) (PEDOT)-based binders, and others.

### [Electrolyte]

In an example embodiment, the electrolyte may be a nonaqueous electrolytic solution, and the nonaqueous electrolytic solution may include a lithium salt as an electrolyte and an organic solvent.

The lithium salt is represented by, for example, Li⁺X⁻, and an anion of the lithium salt (X⁻) may be exemplified by F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻(CF₃SO₂)₃C⁻, CF₃(CF₂)₇SO₃⁻, CF₃CO₂⁻, CH₃CO₂⁻, SCN⁻, (CF₃CF₂SO₂)₂N⁻, and others.

The organic solvent sufficiently dissolves the lithium salt and the additive, and may include an organic compound having no reactivity in a battery. The organic solvent may include, for example, at least one of carbonate-based solvents, ester-based solvents, ether-based solvents, ketone-based solvents, alcohol-based solvents, and aprotic solvents. The organic solvent may include, for example, one or more selected from propylene carbonate, ethylene carbonate, butylene carbonate, diethyl carbonate, dimethyl carbonate, ethyl methyl carbonate, methylpropyl carbonate, ethylpropyl carbonate, dipropyl carbonate, vinylene carbonate, methyl acetate, ethyl acetate, n-propyl acetate, 1,1-dimethylethyl acetate, methyl propionate, ethyl propionate, fluoroethyl acetate, difluoroethyl acetate, trifluoroethyl acetate, dibutylether, tetraethylene glycol dimethylether, diethylene glycol dimethylether, tetrahydrofuran, 2-methyltetrahydrofuran, ethyl alcohol, isopropyl alcohol, dimethylsulfuroxide, acetonitrile, dimethoxyethane, diethoxyethane, sulfolane, γ-butyrolactone, propylene sulfite, and others. In some embodiments, the organic solvent may include materials other than those listed above.

### [Cell Structure]

For example, electrode tabs (positive electrode tab and negative electrode tab) may protrude from the positive electrode current collector and the negative electrode current collector and extend to one side of a case, respectively. The electrode tabs may be connected to electrode leads (positive electrode lead and negative electrode lead) which are fused with the one side of the case and extended or exposed to the outside of the case. For example, a pouch-type case, an angular case, a cylindrical case, a coin-type case, and other cases to extend the electrical connections may be used.

Hereinafter, the example embodiments described above will be described in more detail through the following examples. However, the following examples are only for description and do not limit the scope of a right.

The physical properties of the examples were measured as follows:

### [Method for Measuring Physical Properties]

### 1) Glass Transition Temperature (Tg)

A heat capacity of a sample according to heating at a rate of 10° C./min in a range of −100° C. to 250° C., using a differential scanning calorimetry (DSC) was measured, and a temperature of a middle point of an interval where the heat capacity of the sample rapidly changed was set as a glass transition temperature.

### 2) Thickness

A composite separator was laminated in 10 layers, the thickness was measured at ambient temperature and atmospheric pressure by Mitutoyo (ID-C112X) to derive an average thickness of the 10 layers of the composite separator, and the average thickness was divided by 10 again to determine the thickness of the composite separator. A value obtained by subtracting the thickness of a porous substrate from the thickness of the composite separator was set as a total thickness of the ceramic layer.

### 3) Adhesive Strength

### [Cardboard Test]

A composite separator was cut into a size of 5 cm×10 cm to prepare a specimen, and a black cardboard and a rubber pad having a size of 2 cm×10 cm were placed sequentially on the ceramic layer of the composite separator specimen. The cardboard was pulled out horizontally at a speed of 0.1 m/s for a distance of 60 mm in a state of applying a force of 10 N to the rubber pad using a pressing device, adhesive strength was evaluated depending on a degree of foreign matter smeared on the surface of the cardboard, and the foreign matter may be constituent components of the ceramic layer, for example, inorganic particles, a binder, or a combination thereof.

### [Evaluation of Degree of Smeared Foreign Matter]

After the cardboard test, the surface of the cardboard was photographed with an optical camera and imaged, and an area of the smeared foreign matter was measured. Specifically, an indirect lighting was installed with an LED lamp in the visible light range having a 60° slope, and the cardboard was photographed with a 640 M pixel optical camera at a height of 40 cm from the sample (cardboard). The photographed cardboard image was loaded with an Image J program, only an area through which the separator and the rubber pad were passed was selected and cut using a crop function, an image file format of the cut area was converted into a 8 bit image, and a Sharpen filter was applied to the image to adjust the brightness and the contrast of the image so that it is easy to distinguish between the cardboard and white foreign matter. A threshold was applied to the image to convert it into a binary image, an Analyze Particles function was executed to calculate a ratio of an area occupied by white foreign matter to the total area, and adhesive strength was evaluated based on the following criteria:

$$\begin{matrix}A : < 1.5 \% \\ B : 1.5 \% - 5 \% \\ C : > 5 \%\end{matrix}$$

### Example 1

2 parts by weight of 1,2-benzisothiazolin-3-one (DIO2) as a dispersing agent was mixed with 100 parts by weight of boehmite having an average particle diameter (D50) of 0.3 μm as inorganic particles in water to prepare a slurry having a solid content of 45 wt %.

Carboxymethyl cellulose (CMC) having a degree of substitution of 0.9 and a weight average molecular weight of 200,000 g/mol as a binder and polystyrene-polybutylmethacrylate-polymethylmethacrylate block copolymer (PS-PBMA-PMMA) (D50: 2.5 μm, Tg: 62° C.) as a particulate fusing agent were added to the prepared slurry, so that the weight ratio of inorganic particles/binder/particulate fusing agent was 96/2.3/1.7, thereby preparing a composition for forming a ceramic layer.

Surfaces of a polyethylene film substrate having a thickness of 9 μm (porosity: 35%-45%, SKIET) were subjected to a corona discharge treatment (power density: 2 W/m²) to introduce a surface polar group, and the corona surface treatment at this time was performed at a speed of 5 mpm (meter per minute). The composition for forming a ceramic layer was applied on two opposite surfaces of the corona surface-treated polyethylene film substrate identically, bar-coated, and dried at 50° C. to manufacture a composite separator having ceramic layers at the same thickness formed on two opposite surfaces.

### Example 2

The process was performed in the same manner as in Example 1, except that the weight ratio of inorganic particles/binder/particulate fusing agent was 95/3.3/1.7.

### Example 3

The process was performed in the same manner as in Example 1, except that the weight ratio of inorganic particles/binder/particulate fusing agent was 95/3.8/1.2, and the thickness of the ceramic layer was changed as shown in Table 1.

### Example 4

The process was performed in the same manner as in Example 1, except that the weight ratio of inorganic particles/binder/particulate fusing agent was 96/2/2, and the thickness of the ceramic layer was changed as shown in Table 1.

### Example 5

The process was performed in the same manner as in Example 1, except that the weight ratio of inorganic particles/binder/particulate fusing agent was 95/3/2, and the thickness of the ceramic layer was changed as shown in Table 1.

### Example 6

The process was performed in the same manner as in Example 1, except that the weight ratio of inorganic particles/binder/particulate fusing agent was 95/3.4/1.6, and the thickness of the ceramic layer was changed as shown in Table 1.

### Example 7

The process was performed in the same manner as in Example 1, except that PS-PBMA-PMMA (D50: 5.0 μm, Tg: 62° C.) was used as the particulate fusing agent, the weight ratio of inorganic particles/binder/particulate fusing agent was 95/3.3/1.7, and the thickness of the ceramic layer was changed as shown in Table 1.

### Example 8

The process was performed in the same manner as in Example 7, except that the weight ratio of inorganic particles/binder/particulate fusing agent was 96/2.8/1.2.

### Example 9

The process was performed in the same manner as in Example 7, except that the weight ratio of inorganic particles/binder/particulate fusing agent was 95/3.8/1.2, and the thickness of the ceramic layer was changed as shown in Table 1.

### Comparative Example 1

The process was performed in the same manner as in Example 1, except that the weight ratio of inorganic particles/binder/particulate fusing agent was 97/1.3/1.7.

### Comparative Example 2

The process was performed in the same manner as in Example 1, except that the weight ratio of inorganic particles/binder/particulate fusing agent was 94/4.8/1.2, and the thickness of the ceramic layer was changed as shown in Table 1.

### Comparative Example 3

The process was performed in the same manner as in Example 1, except that the weight ratio of inorganic particles/binder/particulate fusing agent was 97/1/2, and the thickness of the ceramic layer was changed as shown in Table 1.

### Comparative Example 4

The process was performed in the same manner as in Example 1, except that the weight ratio of inorganic particles/binder/particulate fusing agent was 94/4.65/1.35, and the thickness of the ceramic layer was changed as shown in Table 1.

### Comparative Example 5

The process was performed in the same manner as in Example 1, except that polyacrylamide (PAAm) (Mw 200,000 g/mol, Sigma Aldrich) was used as the binder instead of CMC.

### Comparative Example 6

The process was performed in the same manner as in Example 7, except that polyacrylamide (PAAm) (Mw 200,000 g/mol, Sigma Aldrich) was used as the binder instead of CMC.

### Comparative Example 7

The process was performed in the same manner as in Example 1, except that PS-PBMA-PMMA (D50: 0.9 μm, Tg: 62° C.) was used as the particulate fusing agent.

The physical properties of the composite separators obtained in the examples and the comparative examples were measured by the methods described in the [Method for measuring physical properties] above, and the values obtained by calculating the value of the following Equation 1 and truncating the third decimal place are shown in the following Table 1.

The composite separators obtained in the examples and the comparative examples all had ceramic layers having the same thickness on two opposite surfaces of the substrate, and the value of half of the measured total thickness of the ceramic layer measured by the method for measuring physical properties was set as the thickness (T) of the ceramic layer formed on one surface:

$$\frac{T \times ( W 1 + W 2 )}{W 2 \times D} \qquad [ Equation 1 ]$$

wherein T is the thickness (μm) of the ceramic layer; W1 is the content (wt %) of the binder to the total weight of the ceramic layer; W2 is the content (wt %) of the particulate fusing agent to the total weight of the ceramic layer; and D is the average particle diameter (μm) of the particulate fusing agent.

TABLE 1

| | Total | | | | | Heat | |
|---|---|---|---|---|---|---|---|
| | thickness (μm) | | | | | shrinkage | |
| | of ceramic | | | Equation | Adhesive | rate (%) | |
| | layer | T (μm) | D (μm) | 1 | strength | MD | TD |
| Example 1 | 2 | 1 | 2.5 | 0.94 | B | 2 | 1 |
| Example 2 | 2 | 1 | 2.5 | 1.17 | B | 1.9 | 1.2 |
| Example 3 | 2.4 | 1.2 | 2.5 | 2.0 | B | 2 | 0.9 |
| Example 4 | 3 | 1.5 | 2.5 | 1.2 | A | 0.1 | 0.1 |
| Example 5 | 3 | 1.5 | 2.5 | 1.5 | A | 0.2 | 0.1 |
| Example 6 | 3.4 | 1.7 | 2.5 | 2.12 | A | 0.2 | 0.1 |
| Example 7 | 4 | 2 | 5.0 | 1.17 | A | 0.1 | 0.1 |
| Example 8 | 4 | 2 | 5.0 | 1.33 | A | 0.1 | 0.1 |
| Example 9 | 4.4 | 2.2 | 5.0 | 1.83 | A | 0.1 | 0.1 |
| Comparative | 2 | 1 | 2.5 | 0.70 | C | 20 | 19 |
| Example 1 | | | | | | | |
| Comparative | 2.4 | 1.2 | 2.5 | 2.4 | A | 14 | 18 |
| Example 2 | | | | | | | |
| Comparative | 3 | 1.5 | 2.5 | 0.9 | C | 15 | 14 |
| Example 3 | | | | | | | |
| Comparative | 3 | 1.5 | 2.5 | 2.66 | A | 10 | 9 |
| Example 4 | | | | | | | |
| Comparative | 2 | 1 | 2.5 | 0.94 | C | 13 | 12 |
| Example 5 | | | | | | | |
| Comparative | 4 | 2 | 5.0 | 1.17 | C | 15 | 13 |
| Example 6 | | | | | | | |
| Comparative | 2 | 1 | 0.9 | 2.61 | B | 1.8 | 1.2 |
| Example 7 | | | | | | | |

### Evaluation Example

### Evaluation 1. Anti-Blocking Performance

Two sheets of the composite separators obtained in the above examples and comparative examples were placed so that the ceramic layers faced each other, respectively, pressing was performed at a temperature of 25° C. and a pressure of 15 kgf/cm² for 1 hours, the separators were peeled off at 180° in accordance with ASTM D903, and then it was confirmed whether the particulate fusing agent and/or the inorganic particles were desorbed through scanning electron microscope (SEM). 10 random positions were designated, the number of desorbed particulate fusing agent and/or inorganic particles per unit area was counted, the average value of 10 points was derived, and the results of evaluating antiblocking performance by the following criteria are shown in the following Table 2.
∘: the fusing agent or the inorganic particles were not all desorbed, or less than 10⁻⁴/μm² of them were desorbed.
x: 10⁻⁴/μm² or more of the fusing agent or the inorganic particles were desorbed.

### Evaluation 2. Electrode Fusion Strength

A positive electrode and a negative electrode were manufactured as follows, and fusion strength between the electrode and the composite separators obtained in the above examples was evaluated.

94 wt % of LiCoO₂ as a positive active material, 2.5 wt % of polyvinylidene fluoride as an adhesive, and 3.5 wt % of carbon black as a conductive agent were added to N-methyl-2-pyrrolidone (NMP) as a solvent, and stirring was performed to prepare a uniform positive electrode slurry. An aluminum foil having a thickness of 30 μm was coated with the slurry, dried at a temperature of 120° C., and pressed to manufacture a positive electrode plate having a thickness of 150 μm.

95 wt % of artificial graphite as the negative active material, 3 wt % of acrylic latex having Tg of −52° C. (product name: BM900B, solid content: 20 wt %), and 2 wt % of carboxymethyl cellulose (CMC) as a thickener were added to water as the solvent, and stirred, thereby preparing uniform negative electrode slurry. A copper foil having a thickness of 20 μm was coated with the slurry, dried at a temperature of 120° C., and pressed to manufacture a negative electrode plate having a thickness of 150 μm.

A composite separator was laminated between 4 sheets of the positive electrode (negative electrode) manufactured above, and pressing was performed at 90° C. and 1 MPa for 30 seconds using a heat press machine to prepare each fusion strength evaluation sample for the positive electrode and the negative electrode. When the sample was lifted vertically, the number of attached electrodes was counted, and the fusion strength between the composite separator and each of the positive electrode and the negative electrode was evaluated and is shown in the following Table 2.
1/4: 1 out of 4 sheets of electrode were fused.
2/4: 2 out of 4 sheets of electrode were fused.
3/4: 3 out of 4 sheets of electrode were fused.
4/4: 4 out of 4 sheets of electrode were all fused.

TABLE 2

| | | Electrode fusion strength | |
|---|---|---|---|
| | Antiblocking | Positive electrode | Negative electrode |
| Example 1 | ∘ | 4/4 | 4/4 |
| Example 2 | ∘ | 4/4 | 4/4 |
| Example 3 | ∘ | 4/4 | 4/4 |
| Example 4 | ∘ | 4/4 | 4/4 |
| Example 5 | ∘ | 4/4 | 4/4 |
| Example 6 | ∘ | 4/4 | 4/4 |
| Example 7 | ∘ | 4/4 | 4/4 |
| Example 8 | ∘ | 4/4 | 4/4 |
| Example 9 | ∘ | 4/4 | 4/4 |
| Comparative | x | 4/4 | 4/4 |
| Example 1 | | | |
| Comparative | ∘ | 4/4 | 4/4 |
| Example 2 | | | |
| Comparative | x | 4/4 | 4/4 |
| Example 3 | | | |
| Comparative | ∘ | 4/4 | 4/4 |
| Example 4 | | | |
| Comparative | x | 4/4 | 4/4 |
| Example 5 | | | |
| Comparative | x | 4/4 | 4/4 |
| Example 6 | | | |
| Comparative | ∘ | 0/0 | 0/0 |
| Example 7 | | | |

Referring to Tables 1 and 2, it was found that the composite separator based on an example embodiment of the disclosed technology exhibited excellent adhesive strength between the inorganic particles in the ceramic layer as well as excellent adhesive strength between interfaces of the substrate and the ceramic layer, thereby effectively suppressing heat shrinkage. In addition, it was confirmed that the composite separator based on an example embodiment exhibited excellent fusion strength with both the positive electrode and the negative electrode, thereby suppressing desorption and blocking phenomena of inorganic particles and/or a particulate fusing agent when winding the separator. In addition, the composite separator based on an example embodiment exhibited excellent productivity and is favorable for application to actual commercialization, and an electrochemical device employing the composite separator based on an example embodiment simultaneously satisfies safety, a high capacity, and high output characteristics.

However, the composite separators of Comparative Examples 1 to 4, which included the same components as an example embodiment of the disclosed technology, but did not satisfy the range of Equation 1 (0.9<Equation 1<2.4), exhibited reduced adhesion and/or heat resistance, and significantly increased heat shrinkage rates. In addition, it was found that Comparative Example 7 had significantly reduced fusion strength with the electrode and hardly exhibited the fusion strength.

In addition, it was confirmed that Comparative Examples 5 and 6, which employed PAAm as the binder had greatly reduced adhesive strength and heat resistance as compared with the composite separator based on an example embodiment, and exhibited deteriorated air permeability, resulting in an increased air permeability value (sec/100 cc).

In addition, the use of carboxymethyl cellulose (CMC) having a weight average molecular weight of 180,000 g/mol to 280,000 g/mol was found to be particularly important in achieving the desired performance. While other binders or CMCs outside this molecular weight range may result in poor dispersion, insufficient adhesion between ceramic particles, or difficulty in forming a uniform coating layer, CMC within this specified molecular weight range provides sufficient viscosity for stable slurry preparation, strong adhesion between the ceramic particles and between the ceramic layer and the porous substrate, and enhanced thermal stability of the resulting composite separator. For example, as seen in Comparative Examples 5 and 6, where polyacrylamide (PAAm) was used instead of CMC, the composite separators exhibited significantly degraded adhesive strength and heat resistance, even though the other parameters of Equation 1 were maintained within the claimed range. As explained above, when the weight average molecular weight of CMC is less than 180,000 g/mol, sufficient adhesive strength may not be implemented, and when it is more than 280,000 g/mol, the coating layer (ceramic layer) may not be formed. These results suggest that the combination of the numerical relationship of Equation 1 and the use of CMC with the specified molecular weight range is essential to achieve the synergistic and unexpected improvements demonstrated in Tables 1 and 2.

The composite separator based on an example embodiment including a porous substrate; and a ceramic layer including inorganic particles, a binder, and a particulate fusing agent on the substrate may achieve sufficient fusion strength with an electrode without requiring a separate adhesive layer on the ceramic layer, decrease internal resistance, and improve electrical performance.

In addition, although the composite separator based on an example embodiment is formed with a very small thickness, it may exhibit excellent heat resistance as compared with a conventional separator having a ceramic layer of the same thickness and have excellent adhesive strength between inorganic particles and between inorganic particles and the substrate, thereby effectively suppressing desorption of inorganic particles and shrinkage phenomena at a high temperature.

In addition, the composite separator based on an example embodiment may suppress desorption and blocking phenomena of inorganic particles and/or a particulate fusing agent during winding.

In addition, the composite separator based on an example embodiment exhibits excellent productivity and is favorable for practical commercialization. An electrochemical device employing the composite separator based on an example embodiment may simultaneously satisfy safety, a high capacity, and high output characteristics.

The composite separator of the disclosed technology may be widely applied to a green technology field such as electric vehicles, battery charging stations, and other solar power generations and wind power generations using batteries. In addition, the separator of the disclosed technology may be used in eco-friendly electric vehicles, hybrid vehicles, and the like for preventing climate change by suppressing air pollution and greenhouse gas emissions.

Hereinabove, although the disclosed technology has been described by the specific matters and limited example embodiments in the disclosed technology, they have been provided only for assisting the entire understanding of the disclosed technology, and the disclosed technology is not limited to the example embodiments, and various modifications and changes may be made by those skilled in the art to which the disclosed technology pertains from the description.

Only specific examples of implementations of certain embodiments are described. Variations, improvements and enhancements of the disclosed embodiments and other embodiments may be made based on the disclosure of this patent document.

What is claimed is:

1. A composite separator comprising:
a porous substrate; and
a ceramic layer disposed on at least one surface of the porous substrate,
wherein the ceramic layer includes inorganic particles; a binder including carboxymethyl cellulose having a weight average molecular weight in a range of 180,000 g/mol to 280,000 g/mol; and a particulate fusing agent,
wherein the ceramic layer satisfies the following Equation 1:
$$0.9 < \frac{T \times ( W 1 + W 2 )}{W 2 \times D} < 2.4 \qquad [ Equation 1 ]$$
Wherein:
T is a thickness (μm) of the ceramic layer;
W1 is a content (wt %) of the binder relative to a total weight of the ceramic layer;
W2 is a content (wt %) of the particulate fusing agent relative to the total weight of the ceramic layer; and
D is an average particle diameter (μm) of the particulate fusing agent.

2. The composite separator of claim 1, wherein the particulate fusing agent has an average particle diameter (D50) in a range of 1 μm to 10 μm.

3. The composite separator of claim 1, wherein the ceramic layer has a total thickness in a range of 1 μm to 20 μm.

4. The composite separator of claim 1, wherein the carboxymethyl cellulose has a degree of substitution in a range of 0.6 to 1.2.

5. The composite separator of claim 1, wherein the inorganic particles have an average particle diameter (D50) in a range of 0.01 μm to 1 μm.

6. The composite separator of claim 1, wherein the inorganic particles include at least one of boehmite, pseudo-boehmite, BaSO₄, CeO₂, MgO, CaO, ZnO, Al₂O₃, SiO₂, TiO₂, BaTiO₃, HfO₂, SrTiO₃, SnO₂, NiO, ZrO₂, Y₂O₃, or SiC.

7. The composite separator of claim 1, wherein the inorganic particles are included at 90 to 99 wt % with respect to the total weight of the ceramic layer.

8. The composite separator of claim 1, wherein the binder is included at 0.1 wt % to 10 wt % with respect to the total weight of the ceramic layer.

9. The composite separator of claim 1, wherein the particulate fusing agent is included at 0.1 wt % to 10 wt % with respect to the total weight of the ceramic layer.

10. The composite separator of claim 1, wherein the binder and the particulate fusing agent are included at a weight ratio in a range of 5:5 to 8:2.

11. The composite separator of claim 1, wherein the particulate fusing agent has a glass transition temperature (Tg) in a range of 40° C. to 80° C.

12. The composite separator of claim 1, wherein the porous substrate is hydrophilically surface-treated.

13. The composite separator of claim 1, wherein the composite separator exhibits heat shrinkage rates in machine direction (MD) and transverse direction (TD) of 4% or less, wherein the heat shrinkage rates in MD and TD are measured after the composite separator is allowed to stand at 150° C. for 60 minutes.

14. The composite separator of claim 1, wherein, when the composite separator is subjected to a cardboard test, a ratio of an area occupied by foreign matter smeared on a surface of a cardboard to a total area of the cardboard is 5% or less,
wherein the cardboard test comprises:
placing a black cardboard and a rubber pad having a size of 2 cm×10 cm sequentially on a ceramic layer of a composite separator specimen having a size of 5 cm×10 cm;
pulling the cardboard horizontally at a speed of 0.1 m/s while applying a force of 10 N to the rubber pad using a pressing device; and
evaluating a degree of foreign matter smeared on the surface of the cardboard.

15. An electrochemical device comprising a positive electrode, a negative electrode, and a composite separator,
wherein the composite separator includes:
a porous substrate; and
a ceramic layer disposed on at least one surface of the porous substrate,
wherein the ceramic layer includes: inorganic particles; a binder including carboxymethyl cellulose having a weight average molecular weight in a range of 180,000 g/mol to 280,000 g/mol; and a particulate fusing agent,
wherein the ceramic layer satisfies the following Equation 1:
$$0.9 < \frac{T \times ( W 1 + W 2 )}{W 2 \times D} < 2.4 \qquad [ Equation 1 ]$$
Wherein:
T is a thickness (μm) of the ceramic layer;
W1 is a content (wt %) of the binder relative to a total weight of the ceramic layer;
W2 is a content (wt %) of the particulate fusing agent relative to the total weight of the ceramic layer; and
D is an average particle diameter (μm) of the particulate fusing agent.

16. The electrochemical device of claim 15, wherein the particulate fusing agent has an average particle diameter (D50) in a range of 1 μm to 10 μm.

17. The electrochemical device of claim 15, wherein the ceramic layer has a total thickness in a range of 1 μm to 20 μm.

18. The electrochemical device of claim 15, wherein the carboxymethyl cellulose has a degree of substitution in a range of 0.6 to 1.2.

19. The electrochemical device of claim 15, wherein the inorganic particles have an average particle diameter (D50) in a range of 0.01 μm to 1 μm.

20. The electrochemical device of claim 15, wherein the binder and the particulate fusing agent are included at a weight ratio in a range of 5:5 to 8:2.
